(19) United States
(12) Patent Application Publication
(10) Pub. No.: US 2026/0073585 A1
(43) Pub. Date: Mar. 12, 2026

(54) IMAGE PROCESSING METHOD AND APPARATUS, DEVICE, AND MEDIUM

(71) Applicant: Beijing Zitiao Network Technology Co., Ltd., Beijing (CN)

(72) Inventor: Junjie SU, Beijing (CN)

(21) Appl. No.: 19/107,544

(22) PCT Filed: Aug. 29, 2023
(86) PCT No.: PCT/CN2023/115447

§ 371 Date: Feb. 27, 2025

(30) Foreign Application Priority Data
Aug. 31, 2022 (CN) 202211056881.X

(51) Int. Cl. G06T 11/00; G06T 5/30; G06T 5/60

(52) U.S. Cl. CPC G06T 11/10; G06T 5/30; G06T 5/60; G06T 2207/10024; G06T 2207/20081; G06T 2207/20084

(57) ABSTRACT

An image processing method, a device, and a medium are provided. The method includes: acquiring a first transformation graph corresponding to an original graph, where the first transformation graph is an image obtained by transforming a hair color of a target object in the original graph; filtering the first transformation graph according to the original graph to obtain a second transformation graph; and generating a final transformation graph according to the first transformation graph and the second transformation graph, where a hair body of a target object in the final transformation graph is obtained based on a hair body of a target object in the first transformation graph, and a hair edge of the target object in the final transformation graph is obtained based on a hair edge of a target object in the second transformation graph.

This application claims priority of the Chinese Patent Application No. 202211056881.X, which was filed on Aug. 31, 2022, and is hereby incorporated by reference in its entirety.

### TECHNICAL FIELD

Embodiments of the present disclosure relate to an image processing method and apparatus, a device and a medium.

### BACKGROUND

Face effect function has been widely used in many applications, such as an image clip software, a photo software and a video live platform, etc. Users can change the face presentation effect according to the requirements, and changing hair color is also one of the user requirements to change the face presentation effect. However, the inventors have found that hair color transformation techniques are mostly difficult to accurately segment the hair region in the original image, mainly because the hair edge cannot be accurately processed, resulting in poor hair color change.

### SUMMARY

In order to solve the above technical problems or at least partially solve the above technical problems, the present disclosure provides an image processing method and apparatus, a device and a medium.

An embodiment of the present disclosure provides an image processing method, and the method includes: acquiring a first transformation graph corresponding to an original graph, where the first transformation graph is an image obtained by transforming a hair color of a target object in the original graph; filtering the first transformation graph according to the original graph to obtain a second transformation graph; and generating a final transformation graph according to the first transformation graph and the second transformation graph, where a hair body of a target object in the final transformation graph is obtained based on a hair body of a target object in the first transformation graph, and a hair edge of the target object in the final transformation graph is obtained based on a hair edge of a target object in the second transformation graph.

Optionally, gradient information of the second transformation graph corresponds to gradient information of the original graph.

Optionally, the steps of filtering the first transformation graph according to the original graph to obtain a second transformation graph includes: taking the original graph as a guiding graph of a directional filter algorithm, and filtering the first transformation graph based on the guiding graph by using the directional filter algorithm to obtain the second transformation graph.

Optionally, the steps of generating a final transformation graph according to the first transformation graph and the second transformation graph includes: acquiring a hair body mask image of the target object in the first transformation graph; fusing the first transformation graph and the second transformation graph based on the hair body mask image to obtain a third transformation graph, where pixels corresponding to a hair body of a target object in the third transformation graph are pixels corresponding to the hair body of the target object in the first transformation graph, and pixels corresponding to a hair edge and a non-hair region of the target object in the third transformation graph are pixels corresponding to the hair edge and a non-hair region of the target object in the second transformation graph; and fusing the third transformation graph and the first transformation graph to obtain the final transformation graph.

Optionally, the steps of acquiring a hair body mask image of the target object in the first transformation graph includes: acquiring an original hair mask image corresponding to the target object in the original graph; and performing erosion process on the original hair mask image to obtain the hair body mask image of the target object in the first transformation graph.

Optionally, the steps of fusing the third transformation graph and the first transformation graph to obtain the final transformation graph includes: acquiring a complete hair mask image of the target object in the third transformation graph; and fusing the third transformation graph and the first transformation graph based on the complete hair mask image to obtain the final transformation graph, where pixels corresponding to a complete hair of the target object in the final transformation graph are pixels corresponding to a complete hair of the target object in the third transformation graph, and pixels corresponding to remaining regions except for the complete hair in the final transformation graph are pixels corresponding to remaining regions except for a complete hair in the first transformation graph.

Optionally, the steps of acquiring a complete hair mask image of the target object in the third transformation graph includes: acquiring an original hair mask image corresponding to the target object in the original graph; and performing dilation process on the original hair mask image to obtain the complete hair mask image of the target object in the third transformation graph.

Optionally, the steps of the acquiring a first transformation graph corresponding to an original graph includes: inputting the original graph into an initial hair color transformation model to obtain the first transformation graph corresponding to the original graph output by the initial hair color transformation model.

Optionally, the method further includes: replacing the original graph with the final transformation graph, and presenting the final transformation graph on a terminal interface.

Optionally, the method further includes: training a neural network model that is pre-set based on the original graph and the final transformation graph corresponding to the original graph, and taking the neural network model at an end of training as a final hair color transformation model, where the final hair color transformation model is configured to perform a hair color transformation on a person in a target image, and output a final transformation graph of the target image.

An embodiment of the present disclosure further provides an image processing apparatus, which includes: a first transformation graph acquisition module, configured to acquire a first transformation graph corresponding to an original graph, where the first transformation graph is an image obtained by transforming a hair color of a target object in the original graph; a second transformation graph generation module, configured to filter the first transformation graph according to the original graph to obtain a second transformation graph; and a final transformation graph generation module, configured to generate a final transformation graph from the first transformation graph and the second transformation graph, where a hair body of a target object in the final transformation graph is obtained based on a hair body of a target object in the first transformation graph, and a hair edge of the target object in the final transformation graph is obtained based on a hair edge of a target object in the second transformation graph.

An embodiment of the present disclosure further provides an electronic device, which includes: a processor; and a memory configured to store executable instructions, where the processor is configured to read the executable instructions from the memory and execute the executable instructions to implement the image processing method provided by embodiments of the present disclosure.

An embodiment of the present disclosure further provides a computer-readable storage medium, which stores a computer program, and the computer program is configured to execute the image processing method provided by embodiments of the present disclosure.

It should be understood that the content described in this section is not intended to identify the key or important features of the embodiments of the present disclosure, nor is it intended to limit the scope of the present disclosure. Other features of the present disclosure will be easily understood through the following description.

### BRIEF DESCRIPTION OF DRAWINGS

The drawings, which are hereby incorporated in and constitute a part of the present description, illustrate embodiments of the present disclosure, and together with the description, serve to explain the principles of the embodiments of the present disclosure.

To describe the technical solutions in the embodiments of the present disclosure more clearly, the drawings required in the description of the embodiments will be described briefly below. Apparently, other drawings can also be derived from these drawings by those ordinarily skilled in the art without creative efforts.

FIG. 1 is a schematic flowchart of an image processing method provided by an embodiment of the present disclosure;

FIG. 2 is a schematic diagram of a hair color transformation provided by an embodiment of the present disclosure;

FIG. 3 is a schematic flowchart of an image processing method provided by an embodiment of the present disclosure;

FIG. 4 is a structural schematic diagram of an image processing apparatus provided by an embodiment of the present disclosure; and

FIG. 5 is a structural schematic diagram of an electronic device provided by an embodiment of the present disclosure.

### DETAILED DESCRIPTION

To provide a clearer understanding of the objectives, features, and advantages of the present disclosure, the solutions of the present disclosure will be further described below. It should be noted that the embodiments in the present disclosure and features in the embodiments may be combined with one another without conflict.

Many specific details are described below to help fully understand the present disclosure. However, the present disclosure may also be implemented in other manners different from those described herein. Apparently, the described embodiments in the specification are merely some rather than all of the embodiments of the present disclosure.

The inventors have found that the hair segmentation model used in the relevant hair color transformation technology cannot completely and accurately segment the hair region, and hair edge such as scattered hair strands tends to be missed during the hair segmentation and cannot be covered in the hair region obtained by the model segmentation. In this case, the missed hair edge is not colored and still present the original color. For example, when changing black human hair into gold hair, the hair color transformation graph obtained by the related art may show that the hair region is mainly gold, but the hair strands at the hair edge are still black. Furthermore, in the related art, hair segmentation is usually performed first, and the hair region obtained by segmentation is subjected to a color-changing treatment, and then the color-changed hair region is directly attached back to the original image. The hair edge is difficult to be accurately attached, and the color of the original hair may also appear in the final hair color transformation graph. Taking the original hair being black as an example, some black edges may still appear at the hair edge in the hair color transformation graph.

The above-mentioned defects in the hair color transformation technology in the related art are the results obtained by the applicant after practical and careful research. Therefore, the discovery process of the above-mentioned defects and the solutions proposed by the embodiments of the present application for the above-mentioned defects in the following text should be considered as the contributions made by the applicant to the present application.

In order to solve the problem in the related art that hair edge cannot be accurately processed, resulting in poor hair color change effects, the embodiments of the present disclosure provide an image processing method and apparatus, a device and a medium, and are specifically described as follows.

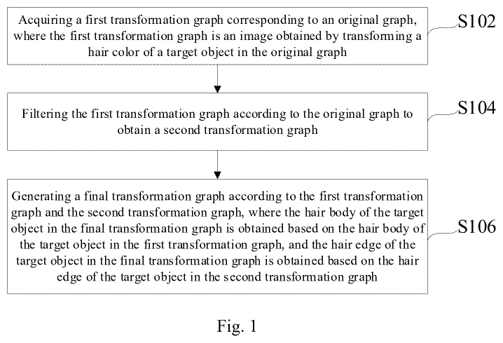

FIG. 1 is a schematic flowchart of an image processing method provided by an embodiment of the present disclosure. The method may be performed by an image processing apparatus, where the apparatus may be implemented in software and/or hardware, and may generally be integrated in an electronic device. As shown in FIG. 1, the method mainly includes the following steps S102-S106.

Step S102, acquiring a first transformation graph corresponding to an original graph, where the first transformation graph is an image obtained by transforming a hair color of a target object in the original graph.

The original image is an image containing at least one object, and the disclosed embodiments do not limit the type of object, which may illustratively be a person. In practice, the original graph may contain only the facial features of the object (such as the human face), or may contain the whole body or half body of the object. The target object may be all the objects contained in the original graph, or may be a user-specified object, without limitation. The above-mentioned first transformation graph, i.e., an image obtained by preliminarily performing a hair color transformation on a target object in an original graph, may use any technique capable of performing the hair color transformation to obtain a first transformation graph corresponding to the original graph, which is not limited thereto. In addition, it should be noted that in the first transformation, only the color of the hair region is changed, and neither other features such as hair texture are adjusted nor the non-hair region is changed. That is, the non-hair region is protected and only the hair color transformation is performed.

However, the hair edge (i.e. the boundary between the hair region and the non-hair region) is mostly irregular. Because it is difficult to accurately process the hair edge as described above, the first transformation graph obtained by transforming the hair color of the target object in the original graph still has the aforementioned problem that the hair edge is not discolored. Compared with directly presenting the first transformation graph to the user in the related art, the embodiment of the present disclosure further optimizes the first transformation graph, specifically referring to the following steps S104 to S106.

Step S104, filtering the first transformation graph according to the original graph to obtain a second transformation graph. In practical applications, the first transformation graph may be filtered according to specified information about the original graph, such as filtering the first transformation graph according to gradient information about the original graph to obtain a second transformation graph, where the gradient information about the second transformation graph corresponds to the gradient information about the original graph. In some examples, the gradient information about the second transformation graph corresponds to the gradient information about the original graph, it indicates that the gradient information about the second transformation graph is similar to the gradient information about the original graph. In particular, the similarity between the gradient information about the second transformation graph and the gradient information about the original graph is greater than a preset similarity threshold value.

If the segmentation result of hair region is not accurate, it may lead to hair edge after hair color transformation has no hair color transformation, and the hair edge presents a certain sense of discontinuity. However, for the original image, the entire hair region is uniform in color and there is basically no sense of discontinuity. In order to ameliorate this problem, the overall gradient of the second transformation graph obtained by the above steps is similar to the overall gradient of the original image, and the color of the hair region is preserved as the hair color in the first transformation graph, which helps to make the hair edge of the second transformation graph as close as possible to the hair edge of the original image, eliminates the sense of discontinuity of at the hair edge to a certain extent, and better preserves the edge details.

In some specific implementation examples, the original graph may be used as a guiding graph (also referred to as a guide graph) of a directional filter algorithm, and the first transformation graph is filtered based on the guiding graph by using the directional filter algorithm to obtain a second transformation graph. By taking the original graph as the guiding graph of the directional filter algorithm and the first transformation graph as the input image of the directional filter algorithm, it can be ensured that the directional filter algorithm is the same as the first transformation graph as possible, and the overall gradient is similar to that of the original graph, so as to achieve the edge-preserving smoothing effect.

Step S106, generating a final transformation graph according to the first transformation graph and the second transformation graph, where the hair body of the target object in the final transformation graph is obtained based on the hair body of the target object in the first transformation graph, and the hair edge of the target object in the final transformation graph is obtained based on the hair edge of the target object in the second transformation graph.

In practice, the first transformation graph and the second transformation graph may be fused to obtain the final transformation graph. According to the above-mentioned technical solution provided by the embodiments of the present disclosure, the hair body of the first transformation graph of the original graph has a different color from the hair body of the original graph, but the hair texture is substantially unchanged. Namely, the texture of the hair body of the first transformation graph is substantially consistent with that of the hair body of the original graph, and the hair body of the final transformation graph is obtained on the basis of the hair body of the first transformation graph, so that the hair texture may be made to be as consistent as possible with the hair texture of the original graph on the basis of the change of the hair color of the final transformation graph. Furthermore, because the gradient information of the second transformation graph obtained by filtering the first transformation graph of the original graph corresponds to the gradient information of the original graph, the second transformation graph may achieve a better edge-preserving smoothing effect, and the hair edge of the second transformation graph is also similar to the hair edge of the original graph. The hair edge of the final transformation graph is obtained based on the hair edge of the second transformation graph. Thus, the hair edge of the final transformation graph may be approximated to the hair edge of the original graph as much as possible on the basis of the change of the hair color of the final transformation graph, and it effectively avoids the problem of hair edge that may not be accurate in the first transformation graph. In summary, in embodiments of the present disclosure, the hair region (hair body and hair edge) of the final transformation graph may achieve better hair color transformation.

In order to conveniently and quickly obtain the first transformation graph with a relatively good effect at the initial stage, in some specific implementation examples, the original graph may be input into an initial hair color transformation model to obtain a first transformation graph corresponding to the original graph output by the initial hair color transformation model. In some embodiments, the initial hair color transformation model may be a neural network model. The embodiments of the present disclosure do not limit the specific implementation of the initial hair color transformation model, and any model having a hair color transformation function in the related art can be used as the initial hair color transformation model. Exemplarily, the initial hair color transformation model may be a CycleGAN (Cycle Generative Adversarial Network) model, which is a GAN network model implementing an image style transformation function, which may implement transformation of specified features. The network structure of the CycleGAN model is not limited by the embodiments of the present disclosure, and both the model network structure and the training method may be implemented with reference to the related art. The CycleGAN model may be used to quickly and efficiently have an elementary hair color transformation on the original image. However, the inventors have found that the CycleGAN model still cannot accurately treat the hair edge when the hair color transformation treatment is performed, and there is a problem that the above-mentioned hair color transformation effect provided by the embodiments of the present disclosure is not good. If the first transformation graph is directly provided to the user, the user experience will be affected. Therefore, the embodiments of the present disclosure may further perform a post-optimization treatment based on the first transformation graph to obtain a final transformation graph with good color-changing effects on both the hair body and the hair edge.

After obtaining the first transformation graph, the embodiment of the present disclosure may perform filtering on the first transformation graph according to the original graph to obtain a second transformation graph with an edge-preserving smoothing effect. On the basis of obtaining the second transformation graph, the embodiment of the present disclosure may further include the step of generating a final transformation graph according to the first transformation graph and the second transformation graph. Exemplarily, the following steps A-C may be referred to.

Step A, acquiring a hair body mask image of the target object in the first transformation graph.

The hair body mask image may also be referred to as a hair body Mask. The hair body mask image can be used for distinguishing a hair body region from a non-hair body region. For example, in the hair body mask image, the pixel value corresponding to the hair body region is 1, and the pixel value corresponding to the non-hair body region is 0. By way of example only, the hair body region and the non-hair body region may be clearly distinguished by setting pixel values such as 0/1 for both the hair body region and the non-hair body region in the hair body mask image. The specific implementation of the mask image can refer to the related art, and will not be described in detail here. The embodiments of the present disclosure fully consider that the hair edge of the target object in the first transformation graph may not be accurate, but the hair body of the target object in the first transformation graph is basically consistent with the hair body of the target object in the original graph except for the color difference. Therefore, only the hair body mask image is obtained in step A, so as to make full use of the hair body of the target object in the first transformation graph, and still retain the original hair texture.

To facilitate understanding, the above-mentioned step A can be realized with reference to the following steps A1 and A2.
Step A1, acquiring an original hair mask image corresponding to the target object in the original graph. The original hair mask image is mainly used for distinguishing the hair region and the non-hair region of the target object in the original image. In practical applications, the hair segmentation model in the related art may be used to perform hair segmentation on the original image to obtain the original hair mask image. The specific hair region segmentation method may refer to the related art and is not limited herein. It should be noted that most hair segmentation methods are not accurate, so the original hair mask image obtained in step Al may also not be accurate, i.e., the hair edge may not be accurate.
Step A2, performing erosion process on the original hair mask image to obtain the hair body mask image of the target object in the first transformation graph.

Because the hair edge of the original hair mask image is not accurate, by performing erosion process on the original hair mask image, the hair region corresponding to the original hair mask image is “reduced”, and the hair edge is removed. The hair body mask image of the target object in the first transformation graph may be obtained, i.e., only the hair body of the target object in the first transformation graph remains.

Step B, fusing the first transformation graph and the second transformation graph based on the hair body mask image to obtain a third transformation graph, where pixels corresponding to the hair body of the target object in the third transformation graph are pixels corresponding to the hair body of the target object in the first transformation graph, and pixels corresponding to the hair edge and the non-hair region of the target object in the third transformation graph are pixels corresponding to the hair edge and the non-hair region of the target object in the second transformation graph.

It can be understood that the textures of the hair bodies of the first transformation graph and the original graph are basically the same, the gradient information of the second transformation graph is similar to the gradient information of the original graph, and the second transformation graph may achieve a better edge-preserving smoothing effect on the basis of the hair color transformation, so that the third transformation graph obtained in the above-mentioned manner may simultaneously have a better hair body presentation effect and a hair edge presentation effect on the basis of the hair color transformation, and avoid the situation that the hair edge is not discolored which may occur in the first transformation graph. That is to say, in the third transformation graph, the non-colored hair edge in the first transformation graph may be eliminated to a greater extent, and the phenomenon that the hair edge is not discolored can hardly occur any more. In order to facilitate understanding, taking the transformation of black hair into gold hair as an example, the problems of black hair strands and black edges remaining due to inaccurate hair edge treatment can hardly occur in the third transformation graph.

Step C, fusing the third transformation graph and the first transformation graph to obtain the final transformation graph.

It can be understood that although the third transformation graph has a better hair color transformation effect, the pixels corresponding to the non-hair region are the pixels corresponding to the non-hair region in the second transformation graph, i.e., the pixels are still affected by the directional filtering process, and have a certain difference from the non-hair region in the first transformation graph. However, generally, the hair transformation process is required to keep the non-hair region unchanged and only change the color of the hair region. Therefore, on the basis that the third transformation graph has a better hair color transformation effect, the third transformation graph and the first transformation graph may be merged. The resulting final transformation graph retains the better hair color transformation effect as well as the original non-hair region. In other words, the complete hair in the third transformation graph can be attached back to the first transformation graph, so that the hair color transformation effect of the first transformation graph is optimized and the non-hair region remains unchanged. In some specific implementation examples, the above-mentioned step C can be implemented with reference to the following steps C1-C2.

Step C1, acquiring a complete hair mask image of the target object in the third transformation graph.

A complete hair mask image may also be referred to as a complete hair Mask. The complete hair mask image may be used to distinguish the hair region and the non-hair body region, where the hair region is a complete hair region, including a hair body and a hair edge. By obtaining the complete hair mask image of the target object in the third transformation graph, the complete hair region of better hair color transformation effect in the third transformation graph may be directly used subsequently. In some specific embodiments, the complete hair mask image may be obtained by referring to the following steps (1) to (2).
(1) Acquiring an original hair mask image corresponding to the target object in the original graph. As previously mentioned, most hair segmentation methods are inaccurate, and therefore the original hair mask image obtained in step (1) may also be inaccurate, i.e., the hair edge may not be accurate.
(2) Performing dilation process on the original hair mask image to obtain the complete hair mask image of the target object in the third transformation graph.

Because the hair edge of the original hair mask image are not accurate, by performing dilation process on the original hair mask image, the hair region corresponding to the original hair mask image is “enlarged” so as to include the hair region that may not be covered in the original hair mask image, thereby obtaining a complete hair mask image. In practical applications, the dilation degree of the above-mentioned collision process is lower than a pre-set degree threshold value, namely, it is only necessary to perform a low-degree dilation process on the original hair mask image.

Step C2, fusing the third transformation graph and the first transformation graph based on the complete hair mask image to obtain the final transformation graph, where pixels corresponding to the complete hair of the target object in the final transformation graph are pixels corresponding to the complete hair of the target object in the third transformation graph, and pixels corresponding to remaining regions except for the complete hair in the final transformation graph are pixels corresponding to remaining regions except for the complete hair in the first transformation graph. The pixels corresponding to the above-mentioned complete hair and the pixels corresponding to the remaining regions other than the complete hair can be distinguished based on the complete hair mask image.

In this way, it is possible to keep the non-hair region unchanged on the basis that the final transformation graph has a better hair color transformation effect.

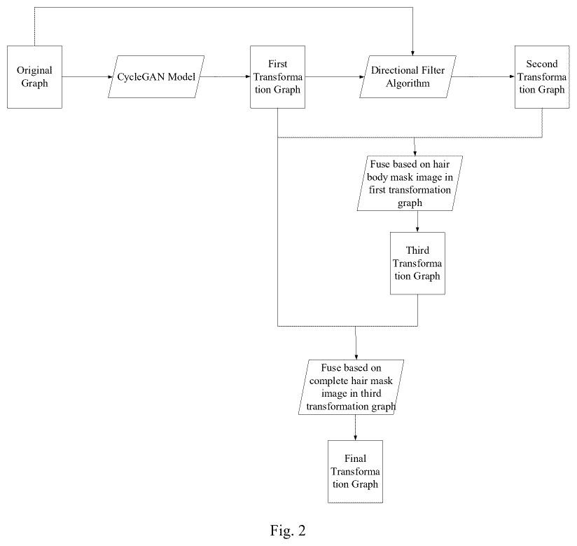

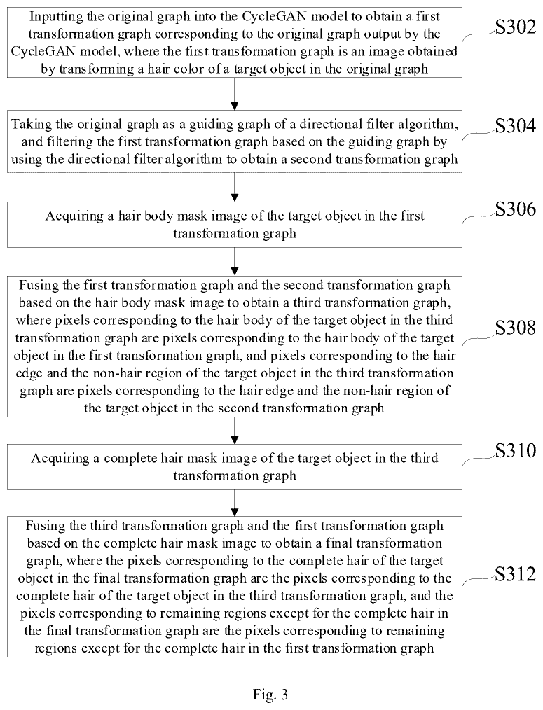

On the basis of the foregoing, the embodiment of the present disclosure also provides a hair color transformation schematic diagram as shown in FIG. 2. For the convenience of understanding FIG. 2, reference can further be made to a schematic flowchart of an image processing method as shown in FIG. 3, which mainly includes the following steps S302 to S310.
Step S302, inputting the original graph into the CycleGAN model to obtain a first transformation graph corresponding to the original graph output by the CycleGAN model, where the first transformation graph is an image obtained by transforming a hair color of a target object in the original graph.
Step S304, taking the original graph as a guiding graph of a directional filter algorithm, and filtering the first transformation graph based on the guiding graph by using the directional filter algorithm to obtain a second transformation graph.
Step S306, acquiring a hair body mask image of the target object in the first transformation graph.
Step S308, fusing the first transformation graph and the second transformation graph based on the hair body mask image to obtain a third transformation graph, where pixels corresponding to the hair body of the target object in the third transformation graph are pixels corresponding to the hair body of the target object in the first transformation graph, and pixels corresponding to the hair edge and the non-hair region of the target object in the third transformation graph are pixels corresponding to the hair edge and the non-hair region of the target object in the second transformation graph.
Step S310, acquiring a complete hair mask image of the target object in the third transformation graph.
Step S312, fusing the third transformation graph and the first transformation graph based on the complete hair mask image to obtain a final transformation graph, where the pixels corresponding to the complete hair of the target object in the final transformation graph are the pixels corresponding to the complete hair of the target object in the third transformation graph, and the pixels corresponding to remaining regions except for the complete hair in the final transformation graph are the pixels corresponding to remaining regions except for the complete hair in the first transformation graph.

Embodiments of the above-mentioned steps provided by the embodiments of the present disclosure can all refer to the above-mentioned relevant contents. Firstly, a preliminary reliable hair color transformation result (a first transformation graph) can be obtained by using a CycleGAN model. Secondly, an edge-preserving smooth second transformation graph is generated by using the guiding filter algorithm; and by fusing the first transformation graph and the second transformation graph based on a hair body mask graph, the obtained third transformation graph can retain a hair body texture in the first transformation graph and a hair edge in the second transformation graph. Therefore, the hair region of the third transformation graph is similar to the original hair in terms of hair texture and hair edge on the basis of hair color change, and can present a better hair color transformation effect. On this basis, the complete hair of the third transformation graph is “attached back” to the first transformation graph, and the obtained final transformation graph can present a better hair color transformation effect, effectively solving the problem that the hair edge is not discolored, etc. and can keep the non-hair region unchanged.

After obtaining the final transformation graph, the embodiment of the present disclosure further gives two application examples of the final transformation graph.
Application example 1: the original graph is replaced by the final transformation graph, and the final transformation graph is presented on the terminal interface. In this example, in various applications, such as a video clip software, a photo software, a video live platform, etc. an original graph is initially collected, and then the hair color in the original graph can be transformed into a color specified by a user according to user settings, and a final transformation graph obtained based on the above-mentioned image processing method can be directly presented on a terminal interface.
Application example 2: a pre-set neural network model is trained based on the original graph and the final transformation graph corresponding to the original graph, and the neural network model at the end of training is taken as a final hair color transformation model, where the final hair color transformation model is configured to perform a hair color transformation on a person in a target image, and output a final transformation graph of the target image.

That is to say, the generated final transformation graph may be used together with the original graph as a sample image for training a model, so as to train a final hair color transformation model which can directly perform hair color transformation on the original graph and can better process the hair region. The final hair color transformation model may be widely used in a variety of applications such as a video clip software, a photo software and a video live platform, so that an application scenario required to perform hair color transformation may directly use the hair color final transformation model to obtain a final transformation graph having a better hair color transformation effect on the complete hair region (hair body and hair edge). It is more convenient and faster to solve the problem that that the hair edge is not discolored.

In summary, the image processing method provided by the embodiments of the present disclosure may effectively enhance the effect of color transformation.

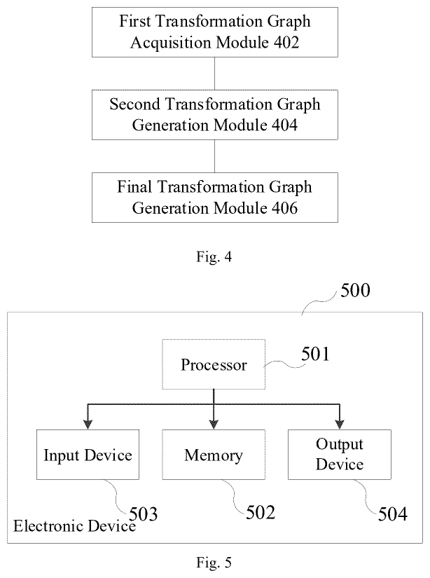

Corresponding to the above-mentioned image processing method, FIG. 4 is a structural schematic diagram of an image processing apparatus provided by an embodiment of the present disclosure. The apparatus may be implemented by software and/or hardware and may be generally integrated in an electronic device, as shown in FIG. 4, including:
a first transformation graph acquisition module 402 configured to acquire a first transformation graph corresponding to an original graph, where the first transformation graph is an image obtained by transforming a hair color of a target object in the original graph;
a second transformation graph generation module 404 configured to filter the first transformation graph according to the original graph to obtain a second transformation graph; and
a final transformation graph generation module 406 configured to generate a final transformation graph according to the first transformation graph and the second transformation graph, where the hair body of the target object in the final transformation graph is obtained based on the hair body of the target object in the first transformation graph; and the hair edge of the target object in the final transformation graph is obtained based on the hair edge of the target object in the second transformation graph.

According to the above-mentioned apparatus provided by the embodiments of the present disclosure, the hair body of the first transformation graph of the original graph has a different color from the hair body of the original graph, but the hair texture is substantially unchanged. Namely, the texture of the hair body of the first transformation graph is substantially consistent with that of the hair body of the original graph, and the hair body of the final transformation graph is obtained on the basis of the hair body of the first transformation graph, so that the hair texture may be made to be as consistent as possible with the hair texture of the original graph on the basis of the change of the hair color of the final transformation graph. Furthermore, because the second transformation graph is obtained by filtering the first transformation graph according to the original graph, the second transformation graph may achieve a better edge-preserving smoothing effect, and the hair edge of the second transformation graph is also similar to the hair edge of the original graph. The hair edge of the final transformation graph is obtained based on the hair edge of the second transformation graph. Thus, the hair edge of the final transformation graph may be approximated to the hair edge of the original graph as much as possible on the basis of the change of the hair color of the final transformation graph, and it effectively avoids the problem of hair edge that may not be accurate in the first transformation graph. In summary, in embodiments of the present disclosure, the hair region (hair body and hair edge) of the final transformation graph may achieve better hair color transformation.

In some implementations, the gradient information of the second transformation graph corresponds to gradient information of the original graph.

In some implementations, the second transformation graph generation module 404 is specifically configured to take the original graph as a guiding graph of a directional filter algorithm, and filter the first transformation graph based on the guiding graph by using the directional filter algorithm to obtain the second transformation graph.

In some implementations, the final transformation graph generation module 406 is specifically configured to acquire a hair body mask image of the target object in the first transformation graph; fuse the first transformation graph and the second transformation graph based on the hair body mask image to obtain a third transformation graph, where pixels corresponding to the hair body of the target object in the third transformation graph are pixels corresponding to the hair body of the target object in the first transformation graph; pixels corresponding to the hair edge and the non-hair region of the target object in the third transformation graph are pixels corresponding to the hair edge and the non-hair region of the target object in the second transformation graph; and fusing the third transformation graph and the first transformation graph to obtain the final transformation graph.

In some implementations, the final transformation graph generation module 406 is specifically configured to acquire an original hair mask image corresponding to the target object in the original graph; and perform erosion process on the original hair mask image to obtain the hair body mask image of the target object in the first transformation graph.

In some implementations, the final transformation graph generation module 406 is specifically configured to acquire a complete hair mask image of the target object in the third transformation graph; and fuse the third transformation graph and the first transformation graph based on the complete hair mask image to obtain the final transformation graph; where pixels corresponding to the complete hair of the target object in the final transformation graph are pixels corresponding to the complete hair of the target object in the third transformation graph; and pixels corresponding to remaining regions except for the complete hair in the final transformation graph are pixels corresponding to remaining regions except for the complete hair in the first transformation graph.

In some implementations, the final transformation graph generation module 406 is specifically configured to acquire an original hair mask image corresponding to the target object in the original graph; and perform dilation process on the original hair mask image to obtain the complete hair mask image of the target object in the third transformation graph.

In some implementations, the first transformation graph acquisition module 402 is specifically configured to input the original graph into an initial hair color transformation model to obtain the first transformation graph corresponding to the original graph output by the initial hair color transformation model.

In some implementations, the apparatus further includes an interface presentation module configured to replace the original graph with the final transformation graph, and present the final transformation graph on a terminal interface.

In some implementations, the apparatus further includes a model training module configured to train a neural network model that is pre-set based on the original graph and the final transformation graph corresponding to the original graph, and take the neural network model at the end of training as a final hair color transformation model, where the final hair color transformation model is configured to perform a hair color transformation on a person in a target image, and output a final transformation graph of the target image.

An image processing apparatus provided by an embodiment of the present disclosure may execute an image processing method provided by any embodiment of the present disclosure, and has corresponding functional modules and advantageous effects of executing the method.

It will be obvious to a person skilled in the art that, for the convenience and brevity of the description, specific working procedures of the above described device and unit embodiment may be referred to corresponding procedures in the preceding method embodiments and will not be described in detail here.

An embodiment of the present disclosure provides an electronic device, which includes: a processor; and a memory configured to store instructions executable by the processor, where the processor is configured to read executable instructions from the memory and execute the instructions to implement the image processing method described above.

FIG. 5 is a structural schematic diagram of an electronic device provided by an embodiment of the present disclosure. As shown in FIG. 5, the electronic device 500 includes one or more processors 501 and a memory 502.

The processor 501 may be a central processing unit (CPU) or other forms of processing units with data processing capabilities and/or instruction executing capabilities, and may control other components in the electronic device 500 to perform desired functions.

The memory 502 may include one or more computer program products, and the computer program products may include various forms of computer-readable storage media, such as volatile memory and/or non-volatile memory. The volatile memory may include, for example, a random access memory (RAM) and/or a cache memory (cache), etc. The non-volatile memory may include, for example, a read-only memory (ROM), a hard disk, a flash memory, etc. One or more computer program instructions may be stored on the computer-readable storage medium, and the processor 501 may run the program instructions to implement the image processing method of the embodiment of the present disclosure described above and/or other desired functions. Various contents such as input signals, signal components, noise components, etc. may also be stored in the computer-readable storage medium.

In an example, the electronic device 500 may also include: an input device 503 and an output device 504, which are interconnected via a bus system and/or other forms of connection mechanisms (not shown).

In addition, the input device 503 may also include, for example, a keyboard, a mouse, etc.

The output device 504 may output various information to the outside, including determined distance information, direction information, etc. The output device 504 may include, for example, a display, a speaker, a printer, and a communication network and a remote output device connected thereto, etc.

Of course, for simplicity, FIG. 5 only shows some of the components related to the present disclosure in the electronic device 500, omitting components such as a bus, an input/output interface, etc. In addition, according to specific application scenarios, the electronic device 500 may also include any other appropriate components.

In addition to the above methods and devices, the embodiments of the present disclosure may also be a computer program product, which includes computer program instructions, which, when executed by a processor, cause the processor to execute the image processing method provided by the embodiments of the present disclosure.

The computer program product may be written in any combination of one or more programming languages to write program codes for executing the operations of the embodiments of the present disclosure, including object-oriented programming languages such as Java, C++, etc., and also conventional procedural programming languages such as “C” language or similar programming languages. The program code may be executed entirely on the user computing device, partially on the user device, as an independent software package, partially on the user computing device, partially on the remote computing device, or entirely on the remote computing device or server.

In addition, the embodiments of the present disclosure may also be a computer-readable storage medium having computer program instructions stored thereon, which, when executed by a processor, cause the processor to execute the image processing method provided by the embodiments of the present disclosure.

The computer-readable storage medium may be any combination of one or more readable medium. The readable medium may be a readable signal medium or a readable storage medium. The readable storage medium may include, for example, but is not limited to, a system, an apparatus or a device of electricity, magnetism, light, electromagnetism, infrared, or semiconductor, or any combinations of the above. More specific examples of readable storage medium (a non-exhaustive list) include: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above.

The present disclosure embodiment also provides a computer program product, including a computer program/instruction, which implements the image processing method in the present disclosure embodiment when executed by a processor.

It should be noted that, in the present disclosure, the relational terms such as “first”, “second”, and the like, are only used to distinguish one entity or operation from another entity or operation, and are not intended to require or imply the existence of any actual relationship or order between these entities or operations. Furthermore, the terms “comprise/comprising”, “include/including”, or any other variations thereof are intended to cover a non-exclusive inclusion such that a process, method, article, or device that includes a list of elements includes not only those elements, but also other elements not expressly listed, or elements inherent to the process, method, article, or device. Without further limitation, an element qualified by the statement “comprises/includes a . . . ” does not exclude the presence of additional identical elements in the process, method, article, or device that includes the element.

What have been described above are only specific implementations of the present disclosure, enabling those skilled in the art to understand or implement the present disclosure. Various modifications to these embodiments are apparent to those skilled in the art, and the generic principles defined herein may be implemented in other embodiments without departing from the spirit or scope of the present disclosure. Therefore, the present disclosure is not to be limited to the embodiments herein but is intended to be accorded the widest scope consistent with the principles and novel features disclosed herein.

1. An image processing method, comprising:
acquiring a first transformation graph corresponding to an original graph, wherein the first transformation graph is an image obtained by transforming a hair color of a target object in the original graph;
filtering the first transformation graph according to the original graph to obtain a second transformation graph; and
generating a final transformation graph according to the first transformation graph and the second transformation graph, wherein a hair body of a target object in the final transformation graph is obtained based on a hair body of a target object in the first transformation graph, and a hair edge of the target object in the final transformation graph is obtained based on a hair edge of a target object in the second transformation graph.

2. The image processing method according to claim 1, wherein gradient information of the second transformation graph corresponds to gradient information of the original graph.

3. The image processing method according to claim 1, wherein the filtering the first transformation graph according to the original graph to obtain a second transformation graph comprises:
taking the original graph as a guiding graph of a directional filter algorithm, and filtering the first transformation graph based on the guiding graph by using the directional filter algorithm to obtain the second transformation graph.

4. The image processing method according to claim 1, wherein the generating a final transformation graph according to the first transformation graph and the second transformation graph comprises:
acquiring a hair body mask image of the target object in the first transformation graph;
fusing the first transformation graph and the second transformation graph based on the hair body mask image to obtain a third transformation graph, wherein pixels corresponding to a hair body of a target object in the third transformation graph are pixels corresponding to the hair body of the target object in the first transformation graph, and pixels corresponding to a hair edge and a non-hair region of the target object in the third transformation graph are pixels corresponding to the hair edge and a non-hair region of the target object in the second transformation graph; and
fusing the third transformation graph and the first transformation graph to obtain the final transformation graph.

5. The image processing method according to claim 4, wherein the acquiring a hair body mask image of the target object in the first transformation graph comprises:
acquiring an original hair mask image corresponding to the target object in the original graph; and
performing erosion process on the original hair mask image to obtain the hair body mask image of the target object in the first transformation graph.

6. The image processing method according to claim 4, wherein the fusing the third transformation graph and the first transformation graph to obtain the final transformation graph comprises:
acquiring a complete hair mask image of the target object in the third transformation graph; and
fusing the third transformation graph and the first transformation graph based on the complete hair mask image to obtain the final transformation graph, wherein pixels corresponding to a complete hair of the target object in the final transformation graph are pixels corresponding to a complete hair of the target object in the third transformation graph, and pixels corresponding to remaining regions except for the complete hair in the final transformation graph are pixels corresponding to remaining regions except for a complete hair in the first transformation graph.

7. The image processing method according to claim 6, wherein the acquiring a complete hair mask image of the target object in the third transformation graph comprises:
acquiring an original hair mask image corresponding to the target object in the original graph; and
performing dilation process on the original hair mask image to obtain the complete hair mask image of the target object in the third transformation graph.

8. The image processing method according to claim 1, wherein the acquiring a first transformation graph corresponding to an original graph comprises:
inputting the original graph into an initial hair color transformation model to obtain the first transformation graph corresponding to the original graph output by the initial hair color transformation model.

9. The image processing method according to claim 1, further comprising:
replacing the original graph with the final transformation graph, and presenting the final transformation graph on a terminal interface.

10. The image processing method according to claim 1, further comprising:
training a neural network model that is pre-set based on the original graph and the final transformation graph corresponding to the original graph, and taking the neural network model at an end of training as a final hair color transformation model,
wherein the final hair color transformation model is configured to perform a hair color transformation on a person in a target image, and output a final transformation graph of the target image.

11. (canceled)

12. An electronic device, comprising:
at least one processor; and
at least one memory configured to store executable instructions,
wherein the at least one processor is configured to read the executable instructions from the at least one memory and execute the executable instructions to implement an image processing method, and the image processing method comprises:
acquiring a first transformation graph corresponding to an original graph, wherein the first transformation graph is an image obtained by transforming a hair color of a target object in the original graph;
filtering the first transformation graph according to the original graph to obtain a second transformation graph; and
generating a final transformation graph according to the first transformation graph and the second transformation graph, wherein a hair body of a target object in the final transformation graph is obtained based on a hair body of a target object in the first transformation graph, and a hair edge of the target object in the final transformation graph is obtained based on a hair edge of a target object in the second transformation graph.

13. A non-transitory computer-readable storage medium storing a computer program, wherein the computer program is configured to execute an image processing method, and the image processing method comprises:
acquiring a first transformation graph corresponding to an original graph, wherein the first transformation graph is an image obtained by transforming a hair color of a target object in the original graph;
filtering the first transformation graph according to the original graph to obtain a second transformation graph; and
generating a final transformation graph according to the first transformation graph and the second transformation graph, wherein a hair body of a target object in the final transformation graph is obtained based on a hair body of a target object in the first transformation graph, and a hair edge of the target object in the final transformation graph is obtained based on a hair edge of a target object in the second transformation graph.

14. The electronic device according to claim 12, wherein gradient information of the second transformation graph corresponds to gradient information of the original graph.

15. The electronic device according to claim 12, wherein the filtering the first transformation graph according to the original graph to obtain a second transformation graph comprises:
taking the original graph as a guiding graph of a directional filter algorithm, and filtering the first transformation graph based on the guiding graph by using the directional filter algorithm to obtain the second transformation graph.

16. The electronic device according to claim 12, wherein the generating a final transformation graph according to the first transformation graph and the second transformation graph comprises:
acquiring a hair body mask image of the target object in the first transformation graph;
fusing the first transformation graph and the second transformation graph based on the hair body mask image to obtain a third transformation graph, wherein pixels corresponding to a hair body of a target object in the third transformation graph are pixels corresponding to the hair body of the target object in the first transformation graph, and pixels corresponding to a hair edge and a non-hair region of the target object in the third transformation graph are pixels corresponding to the hair edge and a non-hair region of the target object in the second transformation graph; and
fusing the third transformation graph and the first transformation graph to obtain the final transformation graph.

17. The electronic device according to claim 16, wherein the acquiring a hair body mask image of the target object in the first transformation graph comprises:
acquiring an original hair mask image corresponding to the target object in the original graph; and
performing erosion process on the original hair mask image to obtain the hair body mask image of the target object in the first transformation graph.

18. The electronic device according to claim 16, wherein the fusing the third transformation graph and the first transformation graph to obtain the final transformation graph comprises:
acquiring a complete hair mask image of the target object in the third transformation graph; and
fusing the third transformation graph and the first transformation graph based on the complete hair mask image to obtain the final transformation graph, wherein pixels corresponding to a complete hair of the target object in the final transformation graph are pixels corresponding to a complete hair of the target object in the third transformation graph, and pixels corresponding to remaining regions except for the complete hair in the final transformation graph are pixels corresponding to remaining regions except for a complete hair in the first transformation graph.

19. The electronic device according to claim 18, wherein the acquiring a complete hair mask image of the target object in the third transformation graph comprises:
acquiring an original hair mask image corresponding to the target object in the original graph; and
performing dilation process on the original hair mask image to obtain the complete hair mask image of the target object in the third transformation graph.

20. The electronic device according to claim 12, wherein the acquiring a first transformation graph corresponding to an original graph comprises:
inputting the original graph into an initial hair color transformation model to obtain the first transformation graph corresponding to the original graph output by the initial hair color transformation model.

21. The electronic device according to claim 12, wherein the image processing method further comprises:
replacing the original graph with the final transformation graph, and presenting the final transformation graph on a terminal interface.
